(19) United States
(12) Patent Application Publication
(10) Pub. No.: US 2011/0251053 A1
(43) Pub. Date: Oct. 13, 2011

(54) SOLVENT-BASED INFILTRATION OF POROUS STRUCTURES

(75) Inventors: Michael C. Tucker, Berkeley, CA (US); Tal Z. Sholklapper, Piedmont, CA (US)

(73) Assignee: The Regents of the University of California, Oakland, CA (US)

(21) Appl. No.: 13/081,915

(22) Filed: Apr. 7, 2011

Related U.S. Application Data
(60) Provisional application No. 61/322,373, filed on Apr. 9, 2010.

(51) Int. Cl. B01J 37/02; B01J 23/34; B05D 3/10

(52) U.S. Cl. 502/303; 427/307

(57) ABSTRACT

A method for infiltrating a metal salt into a porous structure is described wherein the pores of the porous structure are first flooded with a solvent before contacting the salt mixture to the structure. In one embodiment the metal salt is in molten form when brought into contact with the flooded porous structure. In another embodiment, the metal salt is first brought into contact with the porous structure, and the mixture heated to melt the salt and evaporate the solvent. Thereafter the metal salt can be further reacted to convert it to a desired composition.

### CROSS REFERENCE TO RELATED APPLICATIONS

This Non-Provisional US Patent Application claims priority to our earlier filed Provisional U.S. Patent Application Ser. No. 61/322,373, filed Apr. 9, 2010, and entitled Solvent-Based Infiltration of Porous Structures, which provisional application is incorporated herein by reference as if fully set forth in its entirety.

### STATEMENT OF GOVERNMENTAL SUPPORT

The invention described and claimed herein was made in part utilizing funds supplied by the U.S. Department of Energy under Contract No. DE-AC02-05CH11231 between the U.S. Department of Energy and the Regents of the University of California for the management and operation of the Lawrence Berkeley National Laboratory. The government has certain rights in this invention.

### BACKGROUND OF THE INVENTION

1. Field of the Invention

The invention pertains to the infiltration of small particles into a porous structure, which can be useful in modifying the properties of porous structures such as those found in filters, electrochemical devices such as solid oxide fuel cells, medical devices and implants, catalyst beds, and water purification systems.

2. Background Prior Art

Commonly assigned U.S. patent application Ser. No. 11/911,959, filed Oct. 18, 2007, entitled Precursor Infiltration and Coating Method, provides a method of infiltrating small particles into porous structures. The method comprises: melting a mixture of molten metal salts, surfactant, and possibly other additives; infiltrating the molten mixture into a porous structure with or without the assistance of vacuum; and, increasing the temperature of the resulting infiltrated structure to convert the molten salts to very fine particles of metal oxide. The resulting fine particles coat the porous structure and may provide functionality to the surface such as catalysis, biocompatibility, conductivity or insulation, improved wetability, etc. The composition of the molten metal salt mixture is chosen so as to provide the desired composition of the final particles. For example, Ni nitrate is used if Ni or NiO particles are desired, and a mixture of La-nitrate, Sr-nitrate, and Mn-nitrate is used if La—Sr—Mn-oxide is desired.

If the mixture wets the porous substrate well and is of low viscosity, it will wick into the pores by capillary action. However, typical molten salt mixtures are of such viscosity and wetting that vacuum is needed to improve the penetration of the molten salt mixture into the porous structure. The mixture is placed on the external surface of the porous structure, or alternatively the porous structure is submerged in the mixture. Vacuum is then applied, evacuating the pores of the porous structure. When the structure and mixture are returned to atmospheric (or greater) pressure, the mixture is pushed into the pores of the porous structure. This technique increases the total pore volume filled by the mixture, and improves flooding of even the smallest pores in the structure. Pores smaller than 1 μm are routinely flooded by this technique.

This is an effective method of introducing a desired functionality to the pores of a structure. The method is limited in its utility, however, to porous structures that can tolerate vacuum. Furthermore, the equipment and time needed to effect the vacuum-atmospheric pressure cycling step adds complexity and cost to the processing of infiltrated porous structures.

What is thus needed is a method of infiltrating molten metal salts into porous structures without relying on vacuum assistance.

### SUMMARY OF THE INVENTION

The method of the present invention provides a means of infiltrating porous structures with molten metal salts without the use of vacuum assistance. Evacuation of the pores is accomplished by flooding the pores of the porous structure with a solvent before contacting the molten salt to the structure. The solvent is chosen to evaporate or boil off at the molten salt processing temperature. Thus, the solvent exits the pores when the mixture and structure are contacted, and atmospheric pressure pushes the molten salt into the evacuated pores.

### BRIEF DESCRIPTION OF THE DRAWINGS

The foregoing aspects and others will be readily appreciated by the skilled artisan from the following description of illustrative embodiments when read in conjunction with the accompanying drawings.

FIG. 1 is a plot of AC impedance for a cell with catalyst infiltrated according to Example 1, tested in stagnant air at 700° C.

FIG. 2 is a plot of cell potential vs. current density for a cell with catalyst infiltrated according to Example 1, tested in stagnant air at 700° C. The curve labeled “Cathode inside” corresponds to the current direction where reduction happens at the electrode on the inside of the tube. The curve labeled “Cathode outside” corresponds to the current direction where reduction happens at the electrode on the outside of the tube.

FIG. 3 is a SEM micrograph of the structure of material fabricated according to Example 2, prior to infiltration.

FIG. 4 is a SEM micrograph of the pores of the structure fabricated according to Example 2, prior to infiltration.

FIG. 5 is a SEM micrograph of the material of Example 2 after infiltration of the pores with metal salt.

### DETAILED DESCRIPTION

The present invention will be described in the context of infiltrating catalyst compositions nto electrodes of high temperature electrochemical devices such as solid oxide fuel cells, syn-gas generators, oxygen purifiers, and electrolyzers. This does not limit the invention in any way, and applicability to all porous structures is envisioned, including those used in filtration, water purification, catalysis, and medical implants.

The method of the invention comprises three basic steps:

1. Flooding the porous structure with a solvent or other volatile material

2. Contacting the porous structure with a molten salt or a mixture of molten salts.

3. Further processing the structure to convert the salt or mixture of salts to the desired composition

During the first step, the solvent or other volatile material penetrates and fills the pores of the porous structure, displacing the air or other process gas. Ideally, compressible gas is thus entirely excluded from the pores. The solvent-flooded structure is then contacted with the salt mixture in the second step. The salt mixture may already be molten, or the flooded structure and salt mixture may be contacted and then heated together to melt the mixture. As the structure heats up, the solvent boils or evaporates out of the pores. Atmospheric pressure then aids in pushing the molten salt into the pores of the structure. The evacuation of the pores by evaporative removal of the solvent can greatly aid infiltration of the smallest pores in the structure. The final step is accomplished according to commonly assigned U.S. patent application Ser. No. 11/911,959.

Several features of the solvent or other volatile material are desired. It should wet the porous structure and be of sufficiently low viscosity that it floods even the smallest pores of the structure by capillary action. It should have a high vapor pressure or boil at the processing temperature of the molten salt/mixture. This ensures that when the structure is heated in contact with the salt mixture all of the solvent will evaporate or boil out of the pores. For cost, health, or environmental considerations it may be desirable to prevent release of the solvent, in which case the solvent must be easily and economically recovered. Alternatively, the solvent should be inexpensive and harmless enough that release can be tolerated.

In some applications, Step 2 may be accomplished by submerging the porous structure into a bath of the molten salt. In that case, the solvent should be minimally soluble in the molten salt so that it evaporates completely. Otherwise, concentration of the solvent may build up in the molten salt, diluting the mixture.

Suitable solvents include, but are not limited to: water, acetone, ethanol, isopropyl alcohol and hexane. Mixtures of a plurality of solvents, or of a surfactant and a single solvent or plurality of solvents may also suitable, especially when the mixture exhibits: a lower viscosity or boiling point; a higher wettability on the porous structure; or, a higher vapor pressure at the temperature of the molten salt mixture, than the individual components of the mixture. As an example, a mixture of 95.6% ethanol and 4.4% water exhibits a lower boiling point than either pure water or pure ethanol. Suitable metal salts include, but are not limited to: nitrates, chlorides, hydroxides, acetates and citrates of La, Sr, Mn, Cu, Co, Cr, Ni, Ce, Gd, Fe, Sm, Pr, Y, Ca and mixtures thereof, with nitrates in one embodiment being particularly suitable.

### EXAMPLES

In one embodiment, the pores of a multi-layered structure are infiltrated with catalyst by the method of this invention. The object of this embodiment is to provide a structure comprising a dense ceramic containing layer, a porous ceramic containing layer, and/or a porous metal layer. The dense layer and porous layer are generally ceramic or cermet layers that provide functionality to the device. One specific useful dense layer is an electrolyte, and specific useful porous layers are an electrode, electrode backbone that will accept catalytic material in a later cell fabrication step, or barrier layer that prevents reaction between the metal and other layers.

It is to be understood that the invention is not limited to the layers specifically described herein: additional layers not referred herein are within the scope of the invention. While the invention will be described in terms of examples of electrochemical devices it is to be understood that the structures have a variety of applications including filtration of gases or liquids. Filtration requires porous layers and so the dense ceramic containing layer will be omitted.

### Example 1

A tubular, metal-supported solid oxide fuel cell structure was fabricated from yttria-stabilized zirconia (YSZ) and ferritic stainless steel metal according to commonly owned and copending U.S. patent application Ser. No. 12/664,646, filed Dec. 14, 2009, entitled Interlocking Structure for High Temperature Electrochemical Device and Method for Making Same. The structure comprised porous metal/porous YSZ/dense YSZ/porous YSZ/porous metal. The ends of the cell were masked with aqueous acrylic and dried to prevent short-circuiting of the infiltrated catalyst from the inside of the tube to the outside of the tube. The cell was then dipped in acetone, which flooded the pores of the porous YSZ and metal layers. The cell was then transferred immediately into a bath of molten nitrates, held at 105° C. The bath consisted of 0.3 g Triton-X 45 surfactant, 12 g La-nitrate, 9.8 g Mn-nitrate, and 1.08 g Sr-nitrate. Upon dipping the cell into the molten nitrate bath, the acetone boiled off in a few seconds and molten nitrate flooded the pores of the cell. The nitrate salts were then converted to La—Sr—Mn-Oxide catalyst by firing in air at 650° C. for 10 minutes.

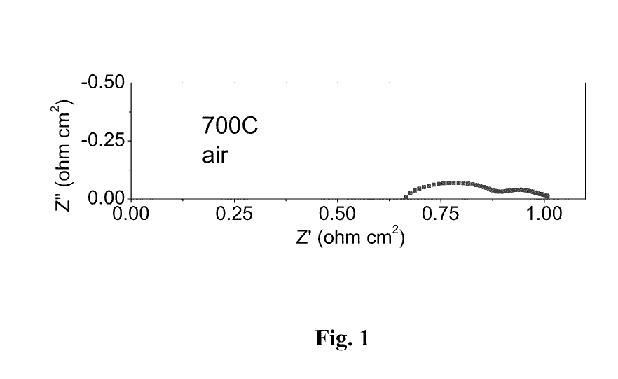

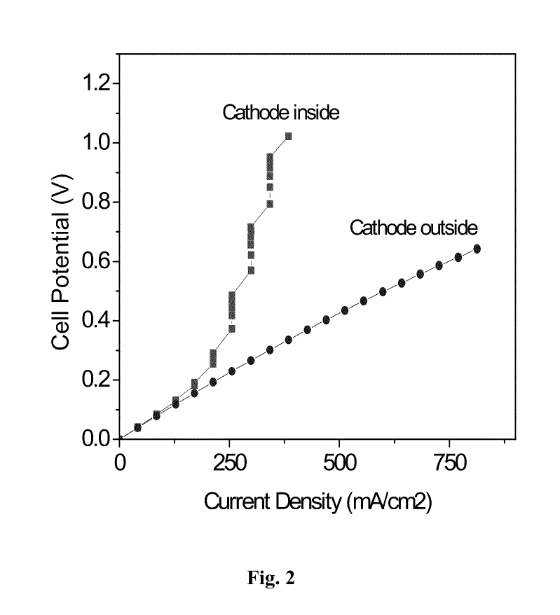

The cell was then tested in oxygen generator mode in air at 700° C. The impedance and polarization behavior of the cell are shown in FIGS. 1 and 2. The cell was run with the outside electrode as cathode and inside electrode as anode. The low ohmic and electrode impedances indicate sufficient infiltration of the catalyst into the YSZ pores. The cell polarization at 500 mA/cm2 was 0.41V. Several similar cells have been prepared previously using the vacuum-infiltration method of U.S. patent application Ser. No. 11/911,959. Those cells achieved 500 mA/cm2 at cell potentials in the range 0.35-0.88V. The present cell, infiltrated by the solvent-based method of this invention, performed nearly as well as the best of the vacuum-infiltrated cells.

### Example 2

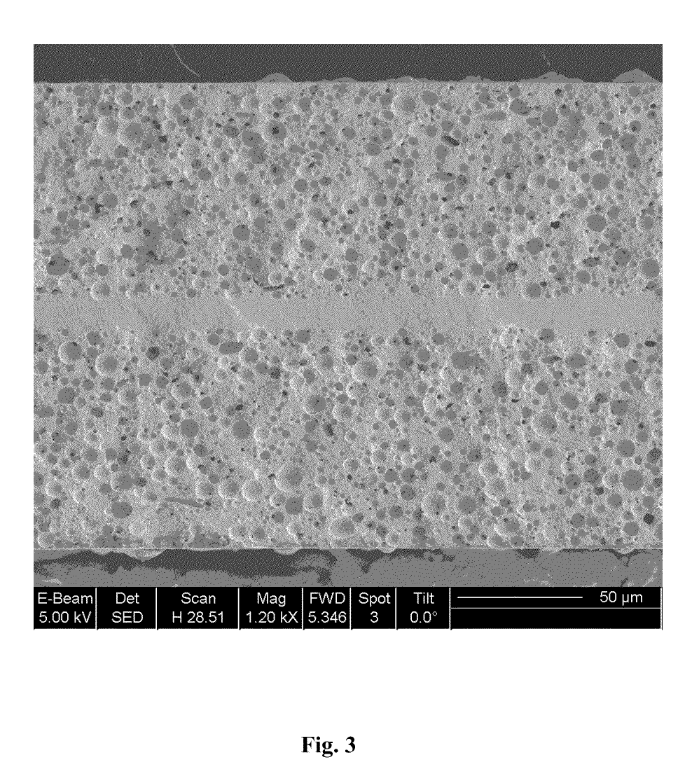

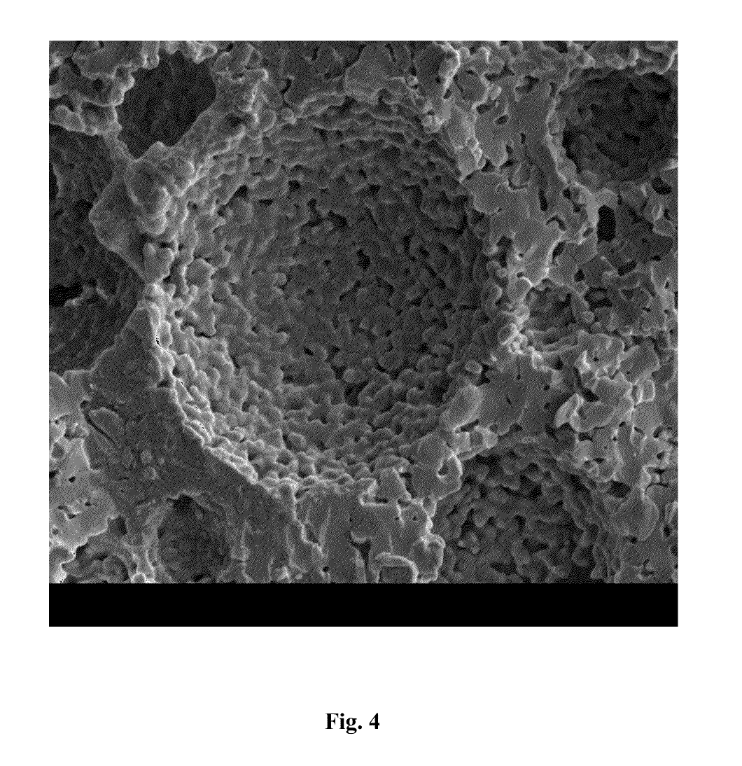

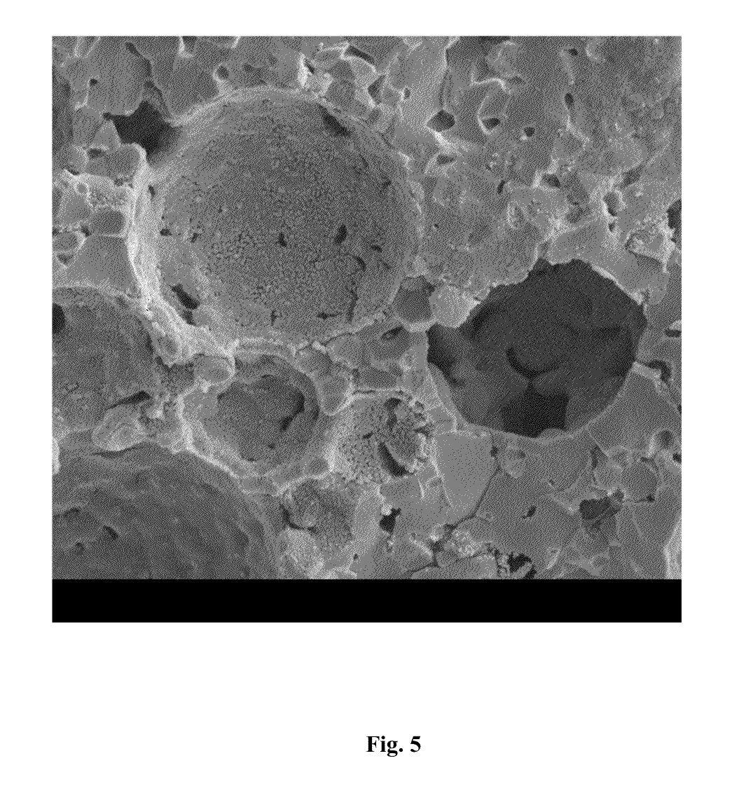

A planar electrode/electrolyte/electrode structure was fabricated from yttria stabilized zirconia (YSZ) by tape casting. The structure comprised porous YSZ/dense YSZ/porous YSZ. The cell was dipped in acetone, which flooded the pores of the porous YSZ layers. The cell was then transferred immediately into a bath of molten nitrates, held at 105° C. The bath consisted of 0.3 g Triton-X 45 surfactant, 12 g La-nitrate, 9.8 g Mn-nitrate, and 1.08 g Sr-nitrated. Upon dipping the cell into the molten nitrate bath, the acetone boiled off in a few seconds and molten nitrate flooded the pores of the cell. The nitrate salts were then converted to La—Sr—Mn-Oxide catalyst by firing in air at 800° C. for 30 minutes. The structures were then imaged with SEM. The structure prior to infiltration is depicted in FIGS. 3 and 4, after infiltration in FIG. 5.

Although the foregoing invention has been described in some detail for purposes of clarity of understanding, it will be apparent that certain changes and modifications may be practiced within the scope of the appended claims. In particular, while the invention is primarily described with reference to solid oxide fuel cells, and other electrochemical devices, such as oxygen generators, electrolyzers, or electrochemical flow reactors, etc., other applications for the methods of preparing infiltrated porous structures in accordance with the present invention will be apparent to those of skill in the art, including filtration, medical devices and implants, water purification and catalysis. It should be noted that there are many alternative ways of implementing the processes of the present invention. Accordingly, the present embodiments are to be considered as illustrative and not restrictive, and the invention is not to be limited to the details given herein.

This invention has been described herein in considerable detail to provide those skilled in the art with information relevant to apply the novel principles and to construct and use such specialized components as are required. However, it is to be understood that the invention can be carried out by different equipment, materials and devices, and that various modifications, both as to the equipment and operating procedures, can be accomplished without departing from the scope of the invention itself.

We claim:

1. A method for infiltrating a metal salt into a porous substrate comprising:
providing a porous structure;
flooding the porous structure with a solvent or other volatile material;
contacting the solvent-flooded porous structure with a metal salt, wherein the salt is heated to the molten state either before or after contact, whereby,
the molten salt infiltrates the porous structure as the solvent evaporates.

2. The method of claim 1 wherein the metal salt is a mixture of metal salts.

3. The method of claim 1 wherein the metal salt is selected from the group comprising metal nitrates, metal chlorides, metal hydroxides, metal acetates, metal citrates, and mixtures thereof.

4. The method of claim 3 wherein the metal salt is a metal nitrate.

5. The method of claim 4 wherein the metal nitrate is a mixture of nitrates comprising nitrates of La, Sr, Mn, Cu, Co, Cr, Ni, Ce, Gd, Fe, Sm, Pr, Y, Ca and mixtures thereof.

6. The method of claim 1 wherein the solvent has a low viscosity and boils at the processing temperature of the molten salt.

7. The method of claim 6 wherein in the solvent is selected from the group comprising water, acetone, ethanol, isopropyl alcohol, hexane, and mixtures thereof.

8. The method of claim 1 wherein the metal salt is heated to the molten state and then brought into contact with the solvent flooded porous structure.

9. The method of claim 8 wherein the molten metal salt is brought into contact with the porous structure by submerging the porous structure into a bath of the molten salt.

10. The method of claim 1 wherein the flooded porous structure in brought into contact with the metal salt, and then the combined composition heated to melt the salt and evaporate the solvent.

11. The method of claim 1 wherein the resulting infiltrated structure is further processed to convert the salt to a desired composition.

12. The method of claim 2 wherein the metal salt is a mixture of La-nitrate, Sr-nitrate and Mn-nitrate.

13. The method of claim 12 wherein the nitrate salts are converted to a catalyst comprising La—Sr—Mn-Oxide by firing the structure in air at 650° C. for 10 minutes.

14. The method of claim 1 wherein the process is carried out at atmospheric pressure.
